(19) United States
(12) Patent Application Publication
(10) Pub. No.: US 2012/0002958 A1
(43) Pub. Date: Jan. 5, 2012

(54) Method And Apparatus For Three Dimensional Capture

(75) Inventor: Mikko J. Muukki, Tampere (FI)

(73) Assignee: Nokia Corporation

(21) Appl. No.: 12/828,771

(22) Filed: Jul. 1, 2010

(51) Int. Cl. G03B 35/00

(52) U.S. Cl. 396/325

(57) ABSTRACT

In accordance with an example embodiment of the present invention, an apparatus is disclosed. The apparatus includes a housing, a first camera, and a second camera. The first camera is connected to the housing. The second camera has a movable lens. The second camera is connected to the housing. The second camera is proximate the first camera. The movable lens is configured to move from a first position to a second position. A field of view of the second camera corresponds to a field of view of the first camera when the movable lens is moved from the first position to the second position.

### TECHNICAL FIELD

The present application relates generally to three dimensional image capture with autofocus cameras.

### BACKGROUND

Interest in various three dimensional (3D) technologies have increased over the last several years and have gained popularity with consumers. In three dimensional (3D) imaging (stereo capture), improved image quality is generally achieved by using two identical cameras, which are placed parallel to each other so that the images can be captured at the same time.

As electronic devices continue to become more sophisticated, these devices provide an increasing amount of functionality by including such applications as, for example, a mobile phone, digital camera, video camera, navigation system, gaming capabilities, and internet browser applications.

Accordingly, as consumers demand increased functionality from electronic devices, there is a need to provide improved devices having increased capabilities, such as 3D capabilities, while maintaining robust and reliable product configurations.

### SUMMARY

Various aspects of examples of the invention are set out in the claims.

According to a first aspect of the present invention, an apparatus is disclosed. The apparatus includes a housing, a first camera, and a second camera. The first camera is connected to the housing. The second camera has a movable lens. The second camera is connected to the housing. The second camera is proximate the first camera. The movable lens is configured to move from a first position to a second position. A field of view of the second camera corresponds to a field of view of the first camera when the movable lens is moved from the first position to the second position.

According to a second aspect of the present invention, a method is disclosed. A housing is provided. A first camera is connected to the housing. The first camera is configured to provide a first object size. A second camera is connected to the housing. The second camera is proximate the first camera. The second camera is configured to provide a second object size. The second camera is configured to be focused in response to a comparison of the first object size and the second object size.

According to a third aspect of the present invention, a computer program product having a computer-readable medium bearing computer program code embodied therein for use with a computer, is disclosed. Code for focusing a first camera. Code for comparing a field of view of the first camera with a field of view of a second camera. Code for focusing the second camera. The focusing is based on, at least partially, the comparing of the field of view of the first camera and the field of view of the second camera.

### BRIEF DESCRIPTION OF THE DRAWINGS

For a more complete understanding of example embodiments of the present invention, reference is now made to the following descriptions taken in connection with the accompanying drawings in which:

FIG. 1 is a front view of an electronic device incorporating features of the invention;

FIG. 2 is a rear view of the electronic device shown in FIG. 1;

FIG. 3 is an interior view of the electronic device shown in FIG. 1;

FIG. 4 is a block diagram of an exemplary method of the device shown in FIG. 1;

FIG. 5 is a perspective view of a portion of the electronic device shown in FIG. 1;

FIG. 6 is a side view of a portion of the electronic device shown in FIG. 1;

FIG. 7 is a block diagram of an exemplary method of the device shown in FIG. 1; and

FIG. 8 is a schematic drawing illustrating components of the electronic device shown in FIG. 1.

### DETAILED DESCRIPTION OF THE DRAWINGS

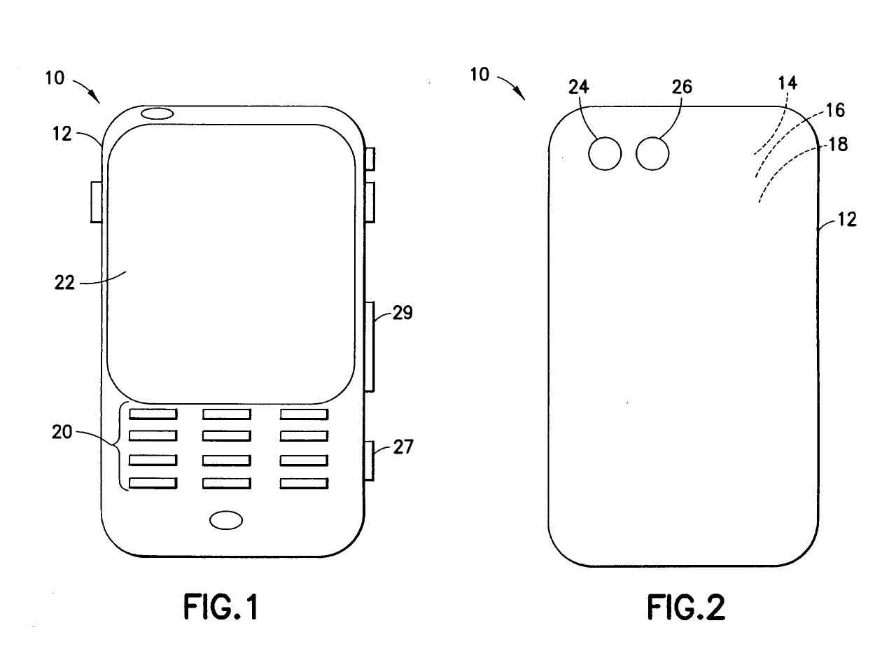

An example embodiment of the present invention and its potential advantages are understood by referring to FIGS. 1 through 8 of the drawings.

Referring to FIG. 1, there is shown a front view of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention shown in FIGS. 1 and 2, the device 10 is a multi-function portable electronic device. However, in alternate embodiments, features of the various embodiments of the invention could be used in any suitable type of portable electronic device such as a mobile phone, a gaming device, a music player, a notebook computer, or a personal digital assistant, for example. In addition, as is known in the art, the device 10 can include multiple features or applications such as a camera, a music player, a game player, or an Internet browser, for example. The device 10 generally comprises a housing 12, a transceiver 14 connected to an antenna 16, electronic circuitry 18, such as a controller and a memory for example, within the housing 12, a user input region 20 and a display 22. The display 22 could also form a user input section, such as a touch screen. It should be noted that in alternate embodiments, the device 10 can have any suitable type of features as known in the art.

The electronic device 10 further comprises a ‘master’ camera 24 and a ‘slave’ camera 26 which are shown as being rearward facing (for example for capturing images and video for local storage) but may alternatively or additionally be forward facing (for example for video calls). The cameras 24, 26 may be controlled by a shutter actuator 27 and optionally by a zoom actuator 29. However, any suitable camera control functions and/or camera user inputs may be provided.

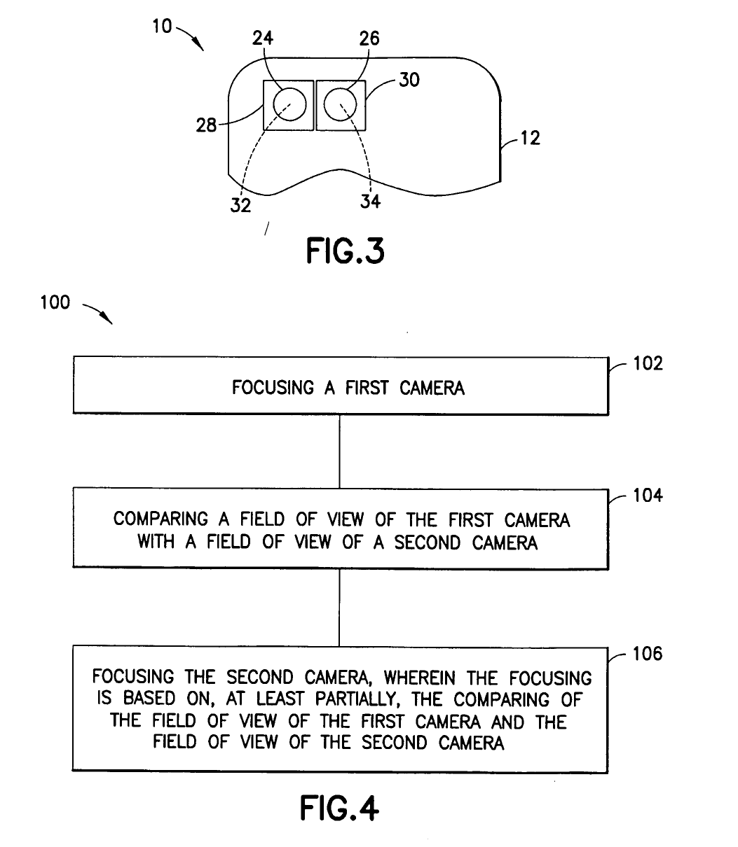

Referring now also to FIG. 3, a view inside the housing 12 is shown wherein camera modules 28, 30 are illustrated. The camera module 28 comprises the camera 24. The camera module 30 comprises the camera 26. However, it should be noted that in alternate embodiments, a single camera module comprising both the master camera and the slave camera may be provided. Additionally, while various exemplary embodiments of the invention are described in connection with two cameras, one skilled in the art will appreciate that the various embodiments are not necessarily so limited and that any suitable number of cameras (or camera modules) may be provided.

The camera 24 comprises one or more lens 32. The lens 32 may comprise any suitable type lens configured for automatic focus (or autofocus) operation/capability. Similarly, the camera 26 comprises one or more lens 34. The lens 32, 34 are configured to be movable independently of each other for focusing, such as autofocus, operations. According to some embodiments of the invention, the cameras 24, 26 and or lens 32, 34 are substantially aligned with each other such that they are spaced in a parallel fashion. However, in alternate embodiments, any suitable alignment/spacing between the cameras and/or lens may be provided.

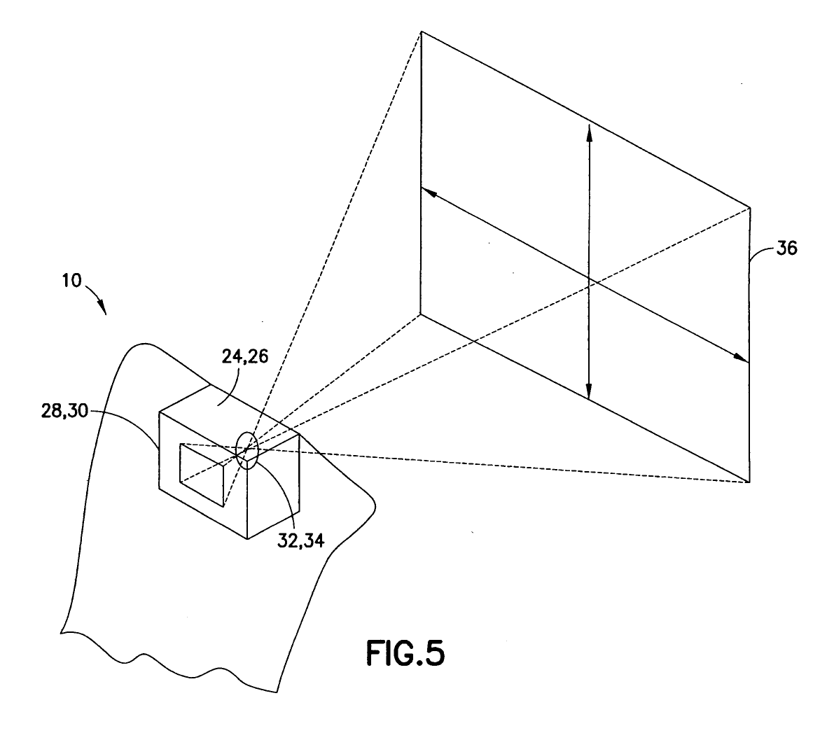

According to various exemplary embodiments of the invention, a method for auto focusing (AF) in three dimensional (3D) imaging is provided. FIG. 4 illustrates a method 100. The method 100 includes focusing a first camera, such as a focusing operation performed with the master camera 24 (at block 102). Comparing a field of view of the first camera, such as the master camera 24, with a field of view of a second camera, such as the slave camera 26 (at block 104). Focusing the second camera, wherein the focusing is based on, at least partially, the comparing of the field of view of the first camera and the field of view of the second camera (at block 106). Performing the focusing by using field of view (FOV) comparison methods is explained further below. It should be noted that the illustration of a particular order of the blocks does not necessarily imply that there is a required or preferred order for the blocks and the order and arrangement of the blocks may be varied. Furthermore it may be possible for some blocks to be omitted.

According to various exemplary embodiments of the invention, a master/slave camera concept may be utilized. For example, first focusing is performed by the master camera 24 and then a correct focusing for the slave camera 26 is predicted by a field of view (FOV) comparison method.

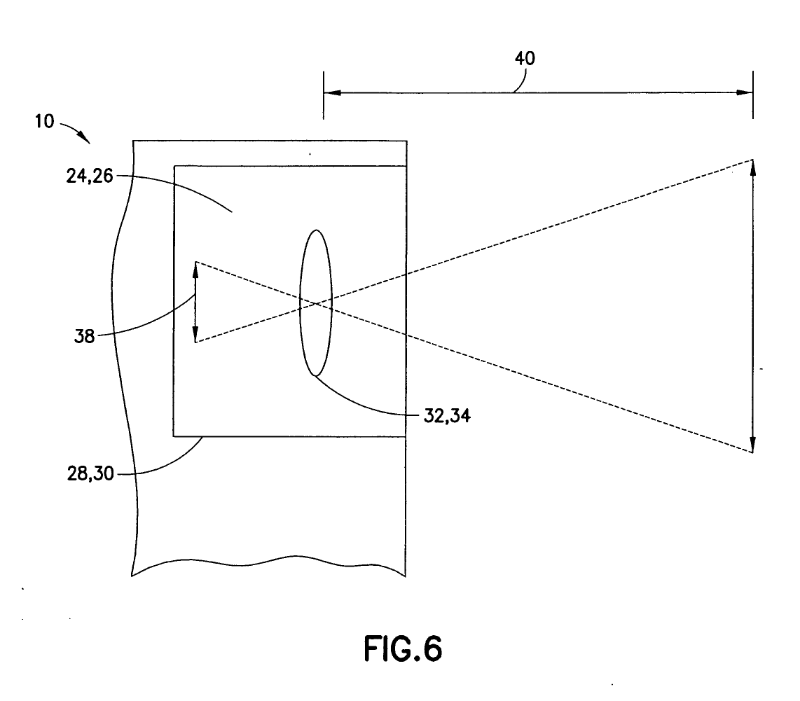

In exemplary field of view comparison methods, various camera properties and/or specifications may be used for focusing operations, such as, a field of view (FOV) 36, object size 38, and or focus point 40, for example (see FIGS. 5, 6). Focusing for the slave camera using field of view comparison methods may include moving the lenses 34 of the slave camera 26 to a position so that the field of view of the slave camera 26 is the same (or proportional/corresponds) as the field of view of the master camera 24. For example, this may be achieved by using a block recognition algorithm and moving the lenses until the object size of the slave camera 26 is the same (or proportional/corresponds) as with the object size of the master camera 24.

According to one embodiment of the invention, the slave camera lenses 34 are moved to a position to provide a field of view of the slave camera 26 that is substantially the same as the field of view of the master camera 24. This may be achieved, for example, by using a block recognition algorithm and moving the lenses of the slave camera 26 until the object size of the slave camera 26 is substantially the same as the object size of master camera 24. With this exemplary method, any further correction of field of view differences is not necessarily needed (as the object size matching corrects the field of view difference). However, if the field of view variation from module to module is large, then the focus may not be absolutely accurate with slave camera. According to some embodiments of the invention, this method may be suitable for viewfinder or video purposes or applications.

According to another exemplary embodiment of the invention, the field of view (FOV) values of both cameras 24, 26 are calibrated, such as in the factory, manufacturing facility, or assembly facility, for example, and thus the FOV difference between the cameras 24, 26 is known. FOV can be calibrated in one focus distance or then in multiple focus distances for example, infinity and close-up/macro distances. FOV difference may be then calculated for different focus point or distances for example using directly calibrated values or by estimating FOV differences based one or more calibrated values for intermediate focus distances. The slave camera lenses 34 may be moved to a position such that the object size is substantially the same to that of the target object size. The target object size may be found by an equation where the calibrated FOV difference is mapped to the object size difference. For example, since the cameras 24, 26 generally each have a different FOV, because of this reason the same focus (or focus point) may not be provided in the lens position where the same object size is achieved. This is then compensated for by using the target object size which is adjusted from the master camera 24 object size based on the known FOV differences. With this exemplary method, there will generally be a FOV difference after focusing. The FOV difference after focusing may then be corrected by cropping the larger FOV image to substantially the same FOV as the smaller FOV image. This may further be followed by the scaling of the larger resolution image so that the image sizes are substantially the same. According to various exemplary embodiments either downscaling or upscaling may be provided, however, it should be noted that downscaling generally does not reduce image quality as compared to upscaling. As a result of the FOV comparison and the extra processing steps (such as the cropping and/or scaling operations), two images may be generated, each having substantially the same focus point, substantially the same FOV, and substantially the same image resolution (pixel count).

Technical effects of any one or more of the exemplary embodiments provide a three dimensional (3D) image capture device (which in particular allows for auto focus using a field of view (FOV) comparison method for three dimensional capture) which provides various improvements and advantages when compared to conventional configurations. Due to mass production variations, it is generally not possible, or at least very difficult to have ‘identical’ cameras. For example it generally difficult to have the same focus point two cameras (especially for cameras configured for autofocus operations). Additionally, the field of view (FOV) of the cameras changes when the focusing is performed. This is somewhat contradictory to the general elements used for three dimensional image capture, which is that the two cameras should have the same FOV.

Various exemplary embodiments of the invention provide for auto focus (AF) capabilities that works reliably in three dimensional (3D) imaging, which alleviates the problems of mass production variations in three dimensional image capture applications related to auto focus.

Additionally, various alternative methods may include, for example, performing the auto focus operations for both cameras separately. However, it is generally difficult to find exactly the same focus point, and it is also generally difficult to provide the same field of view for both of the cameras. Other various alternative methods may, for example, perform the auto focus operations for the master camera, and then applying the same lens position for the slave camera. However, in practice the exact lens position can not generally be known with mobile cameras due to excessive module to module variation (additionally, it is generally difficult to get the same field of view).

With respect to the above mentioned excessive module to module variation, even if the auto focus functionality of the two cameras is calibrated, the calibration data is generally only valid in the same environmental conditions as the calibration station (for example, considering factor such as, orientation, temperature, operational age, dropping or no dropping). Due to the nature of unreliable calibration information, it is generally not possible, or at least difficult, to know the exact absolute position of the lenses/focus. Also, the inaccuracy of camera parameters, compared to calibration information is likely to be different between cameras (for example, dropping likely does not affect the two cameras in an identical way). Thus, having identical focusing for both cameras with these alternative methods is substantially difficult.

While various exemplary embodiments of the invention have been described in connection with moving lens or lenses of the slave camera with respect to the master camera, one skilled in the art will appreciate that the various embodiments of the invention are not necessarily so limited and that any suitable lens movement, such as movement of the master camera lens or lenses with respect to the slave camera, may be provided.

According to various exemplary embodiments of the invention, three dimensional image capture may be provide for either ‘video’ or ‘still’ images. For example, in still capture, various example embodiments may be used directly (such as first focusing for the master camera and then for slave camera). For example, in video (or in continuous focusing) it may be beneficial to adjust the slave camera by similar step sizes as the master camera to reduce the effect of field of view (FOV) changes or focus differences. Additionally, priority should be on the FOV changes (in order to maintain the FOVs the same or close to same).

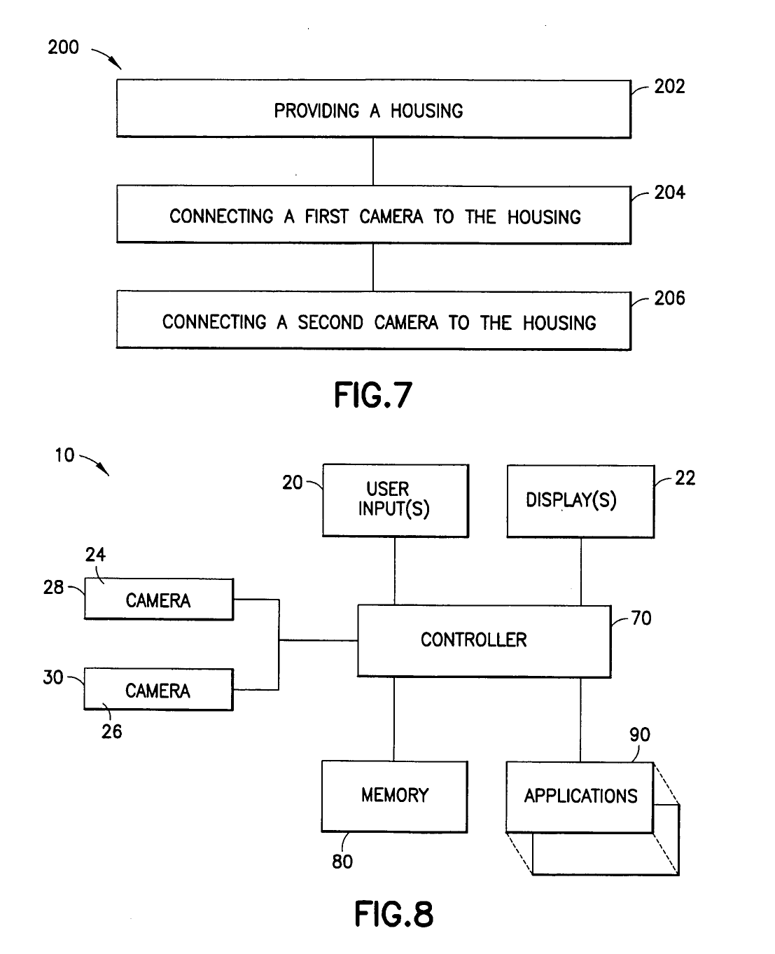

FIG. 7 illustrates a method 200. The method 200 includes providing a housing (at block 202). Connecting a first camera to the housing, wherein the first camera is configured to provide a first object size (at block 204). Connecting a second camera to the housing, wherein the second camera is proximate the first camera, wherein the second camera is configured to provide a second object size, and wherein the second camera is configured to be focused in response to a comparison of the first object size and the second object size (at block 206). It should be noted that the illustration of a particular order of the blocks does not necessarily imply that there is a required or preferred order for the blocks and the order and arrangement of the blocks may be varied. Furthermore it may be possible for some blocks to be omitted.

Without in any way limiting the scope, interpretation, or application of the claims appearing below, a technical effect of one or more of the example embodiments disclosed herein is that absolute focus accuracy may be achieved even maintaining the same field of view (FOV) with the extra processing steps (and the extra processing steps (such as scaling, for example) are easily implemented). Another technical effect of one or more of the example embodiments disclosed herein is proving three dimensional imaging, wherein the generation of two images with the same focus point, the same FOV, and the same image resolution, is provided. Another technical effect of one or more of the example embodiments disclosed herein is that object size matching and FOV difference is used for auto focus purposes, and simultaneously also correcting FOV differences (FOV difference in three dimensional imaging). Another technical effect of one or more of the example embodiments disclosed herein is providing reliable (and easily implemented) auto focus operations that can be used in three dimensional image capturing. Another technical effect of one or more of the example embodiments disclosed herein is providing for automatically correcting the different FOV that changes when autofocus functionality is used (for example as auto focus changes focal length of the camera, which changes the FOV).

Referring now also to FIG. 8, the device 10 generally comprises a controller 70 such as a computer, data processor, or microprocessor, for example. The electronic circuitry includes a memory 80 coupled to the controller 70, such as on a printed circuit board for example. The memory could include multiple memories including removable memory modules for example. The device has applications 90, such as software, which the user can use. The applications can include, for example, a telephone application, an Internet browsing application, a game playing application, a digital camera application (such as a digital camera having auto focus functionality, for example), a video camera application (such as a video camera having auto focus functionality, for example), a map/gps application, etc. These are only some examples and should not be considered as limiting. One or more user inputs 20 are coupled to the controller and one or more displays 22 are coupled to the controller 70. The camera module 28 (comprising the camera 24) and the camera module 30 (comprising the camera 26) are also coupled to the controller 70. The device 10 may programmed to automatically provide autofocus functions using a field of view comparison method for three dimensional image capture. However, in an alternate embodiment, this might not be automatic.

It should be understood that components of the invention can be operationally coupled or connected and that any number or combination of intervening elements can exist (including no intervening elements). The connections can be direct or indirect and additionally there can merely be a functional relationship between components.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Embodiments of the present invention may be implemented in software, hardware, application logic or a combination of software, hardware and application logic. The software, application logic and/or hardware may reside on the electronic device (such as the memory 80, or another memory of the device, for example). If desired, part of the software, application logic and/or hardware may reside on any other suitable location, or for example, any other suitable equipment/location. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 8. A computer-readable medium may comprise a computer-readable storage medium that may be any media or means that can contain or store the instructions for use by or in connection with an instruction execution system, apparatus, or device, such as a computer.

According to one example of the invention, an apparatus is disclosed. The apparatus includes a housing, a first camera, and a second camera. The first camera is connected to the housing. The second camera has a movable lens. The second camera is connected to the housing. The second camera is proximate the first camera. The movable lens is configured to move from a first position to a second position. A field of view of the second camera corresponds to a field of view of the first camera when the movable lens is moved from the first position to the second position.

According to another example of the invention, a program storage device readable by a machine, tangibly embodying a program of instructions executable by the machine for performing operations to provide autofocus functions using a field of view comparison method for three dimensional image capture is disclosed. For example, a computer program product comprising a computer-readable medium bearing computer program code embodied therein for use with a computer, the computer program code comprising: code for focusing a first camera. Code for comparing a field of view of the first camera with a field of view of a second camera. Code for focusing the second camera, wherein the focusing is based on, at least partially, the comparing of the field of view of the first camera and the field of view of the second camera.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a housing;
a first camera connected to the housing; and
a second camera having a movable lens, wherein the second camera is connected to the housing, wherein the second camera is proximate the first camera, wherein the movable lens is configured to move from a first position to a second position, and wherein a field of view of the second camera corresponds to a field of view of the first camera when the movable lens is moved from the first position to the second position.

2. An apparatus as in claim 1 wherein the first camera is configured to provide a first object size, wherein the second camera is configured to provide a second object size, and wherein the second camera is configured to be focused in response to a comparison of the first object size and the second object size.

3. An apparatus as in claim 1 wherein the first camera and the second camera are substantially parallel to each other.

4. An apparatus as in claim 1 wherein the second camera is configured to be focused based on, at least partially, a comparison of the field of view of the first camera and the filed of view of the second camera.

5. An apparatus as in claim 1 wherein the apparatus is configured to provide automatic focus functionality to the first camera and the second camera using object size matching and field of view difference.

6. An apparatus as in claim 1 wherein a field of view difference between the first camera and the second camera is configured to be provided based on a calibration of the first camera and the second camera.

7. An apparatus as in claim 1 wherein the first and second cameras are configured to capture a three dimensional image.

8. An apparatus as in claim 1 wherein the apparatus further comprises a processor configured to:
focus the first camera;
compare the field of view of the first camera with the field of view of the second camera; and
focus the second camera, wherein the focusing is based on, at least partially, the comparing of the field of view of the first camera and the field of view of the second camera.

9. An apparatus as in claim 8 wherein the processor comprises at least one memory that contains executable instructions that if executed by the processor cause the apparatus to focus the first camera, compare the field of view of the first camera with the field of view of the second camera, and focus the second camera, wherein the focusing is based on, at least partially, the comparing of the field of view of the first camera and the field of view of the second camera.

10. An apparatus as in claim 1 wherein the apparatus comprises a mobile phone.

11. A method, comprising:
providing a housing;
connecting a first camera to the housing, wherein the first camera is configured to provide a first object size; and
connecting a second camera to the housing, wherein the second camera is proximate the first camera, wherein the second camera is configured to provide a second object size, and wherein the second camera is configured to be focused in response to a comparison of the first object size and the second object size.

12. A method as in claim 11 wherein at least a portion of the second camera is movable relative to the first camera.

13. A method as in claim 11 wherein the second camera comprises a movable lens, wherein the movable lens is configured to move from a first position to a second position, and wherein a field of view of the second camera corresponds to a field of view of the first camera when the movable lens is moved from the first position to the second position.

14. A method as in claim 11 further comprising:
calibrating a field of view value of the first camera and the second camera.

15. A method as in claim 11 wherein the first camera and the second camera are configured to generate two images with substantially the same focus point and substantially the same field of view.

16. A method as in claim 11 wherein the connecting of the first camera and the connecting of the second camera further comprises connecting the first and second cameras substantially parallel to each other, and wherein the first and second cameras are configured to capture a three dimensional image.

17. A computer program product comprising a computer-readable medium bearing computer program code embodied therein for use with a computer, the computer program code comprising:
code for focusing a first camera;
code for comparing a field of view of the first camera with a field of view of a second camera; and
code for focusing the second camera, wherein the focusing is based on, at least partially, the comparing of the field of view of the first camera and the field of view of the second camera.

18. A computer program product as in claim 17 wherein the focusing is further based on, at least partially, a block recognition algorithm and a relative movement of lens of the second camera and lens of the first camera, and wherein the focusing is associated with three dimensional image capture.

19. A computer program product as in claim 17 wherein the focusing is further based on, at least partially, a calibration of field of view values for the first camera and the second camera, and wherein the focusing is associated with three dimensional image capture.

20. A computer program product as in claim 17 wherein the computer program code further comprises:
code for cropping and/or scaling an image captured by one of the first or second cameras to correct a field of view difference between the field of view of the first camera and the field of view of the second camera.
